(19) United States
(12) Patent Application Publication
(10) Pub. No.: US 2018/0374341 A1
(43) Pub. Date: Dec. 27, 2018

(54) SYSTEMS AND METHODS FOR PREDICTING TRAFFIC PATTERNS IN AN AUTONOMOUS VEHICLE

(71) Applicant: GM GLOBAL TECHNOLOGY OPERATIONS LLC, Detroit, MI (US)

(72) Inventors: ELLIOT BRANSON, SAN FRANCISCO, CA (US); HAGGAI NUCHI, SAN FRANCISCO, CA (US)

(73) Assignee: GM GLOBAL TECHNOLOGY OPERATIONS LLC, Detroit, MI (US)

(21) Appl. No.: 15/634,947

(22) Filed: Jun. 27, 2017

(51) Int. Cl. G08G 1/01; G08G 1/052; G08G 1/056; G07C 5/00

(52) U.S. Cl. CPC G08G 1/0112; G08G 1/0125; G07C 5/008; G08G 1/056; G08G 1/052

(57) ABSTRACT

Systems and method are provided for controlling a vehicle. In one embodiment, a method of predicting traffic patterns includes providing, within an autonomous vehicle, a first set of prediction policies. The method further includes receiving traffic pattern data associated with an object observed by the autonomous vehicle, the traffic pattern data including a kinematic estimate for the object, a position sequence for the object, and road semantics associated with a region near the object. A predicted path for the object is determined based on the first set of prediction policies and the traffic pattern data, and an actual path for the object is determined. A new prediction policy for the object is determined if the difference between the predicted path and the actual path is above a predetermined threshold. A second set of prediction policies is produced based on the first set of prediction policies and the new policy.

### TECHNICAL FIELD

The present disclosure generally relates to autonomous vehicles, and more particularly relates to systems and methods for predicting traffic patterns of vehicles and objects in the vicinity of autonomous vehicles.

### BACKGROUND

An autonomous vehicle is a vehicle that is capable of sensing its environment and navigating with little or no user input. It does so by using sensing devices such as radar, lidar, image sensors, and the like. Autonomous vehicles further use information from global positioning systems (GPS) technology, navigation systems, vehicle-to-vehicle communication, vehicle-to-infrastructure technology, and/or drive-by-wire systems to navigate the vehicle and perform traffic prediction.

While recent years have seen significant advancements in navigation systems and traffic prediction, such systems might still be improved in a number of respects. For example, an autonomous vehicle will typically encounter, during normal operation, a large number of vehicles and other objects, each of which might exhibit its own, hard-to-predict behavior. That is, even when an autonomous vehicle has an accurate semantic understanding of the roadway and has correctly detected and classified objects in its vicinity, the vehicle may yet be unable to accurately predict the trajectory and/or paths of certain objects in a variety of contexts.

Accordingly, it is desirable to provide systems and methods that are capable of predicting the behavior of objects encountered by an autonomous vehicle. Furthermore, other desirable features and characteristics of the present invention will become apparent from the subsequent detailed description and the appended claims, taken in conjunction with the accompanying drawings and the foregoing technical field and background.

### SUMMARY

Systems and method are provided for controlling a vehicle. In one embodiment, a traffic pattern prediction method includes providing, within an autonomous vehicle, a first set of prediction policies. The method further includes receiving traffic pattern data associated with an object observed by the autonomous vehicle, the traffic pattern data including a kinematic estimate for the object, a position sequence for the object, and road semantics associated with a region near the object. The traffic pattern data may also include data relating to the shape and/or size of the object. A predicted path for the object is determined based on the first set of prediction policies and the traffic pattern data, and an actual path for the object is determined. A new prediction policy for the object is determined if the difference between the predicted path and the actual path is above a predetermined threshold. A second set of prediction policies is produced based on the first set of prediction policies and the new policy.

In one embodiment, the kinematic estimate includes at least one of a velocity, an acceleration, and a turn rate of the observed object.

In one embodiment, the traffic pattern data further includes an estimate of the physical dimensions of the object.

In one embodiment, determining the new prediction policy is performed by a server remote from the autonomous vehicle.

In one embodiment, the first set of prediction policies includes a plurality of vehicle maneuvers.

In one embodiment, the difference between the predicted path and the actual path is a sum-of-squares difference.

In one embodiment, the road semantics include at least one of road labels, lane boundaries, lane connectivity, and drivable areas of the roadway.

In one embodiment, a system for controlling a vehicle includes a sensor system configured to observe an object in an environment associated with the vehicle, and a policy learning module, communicatively coupled to the sensor system, including a first set of prediction policies. The policy learning module is configured to: receive traffic pattern data associated with an object observed by the autonomous vehicle, the traffic pattern data including a kinematic estimate for the object, a position sequence for the object, and road semantics associated with a region near the object; determine a predicted path for the object based on the first set of prediction policies and the traffic pattern data; determine an actual path for the object; determine a new prediction policy for the object if the difference between the predicted path and the actual path is above a predetermined threshold; and modify the first set of prediction policies based on the new policy.

In one embodiment, the kinematic estimate includes at least one of a velocity, an acceleration, and a turn rate of the observed object.

In one embodiment, the traffic pattern data further includes an estimate of the physical dimensions of the object.

In one embodiment, the new prediction policy is determined by a server remote from the autonomous vehicle.

In one embodiment, the first set of prediction policies includes a plurality of vehicle maneuvers.

In one embodiment, the difference between the predicted path and the actual path is a sum-of-squares difference.

In one embodiment, the road semantics include at least one of road labels, lane boundaries, lane connectivity, and drivable areas of the roadway.

An autonomous vehicle in accordance with one embodiment includes a sensor system configured to observe an object in an environment associated with the vehicle; and a policy learning module, communicatively coupled to the sensor system, including a first set of prediction policies. The policy learning module configured to: receive traffic pattern data associated with an object observed by the autonomous vehicle, the traffic pattern data including a kinematic estimate for the object, a position sequence for the object, and road semantics associated with a region near the object; determine a predicted path for the object based on the first set of prediction policies and the traffic pattern data; determine an actual path for the object; determine a new prediction policy for the object if the difference between the predicted path and the actual path is above a predetermined threshold; and modify the first set of prediction policies based on the new policy.

In one embodiment, the kinematic estimate includes at least one of a velocity, an acceleration, and a turn rate of the observed object.

In one embodiment, the traffic pattern data further includes an estimate of the physical dimensions of the object.

In one embodiment, the new prediction policy is determined by a server remote from the autonomous vehicle.

In one embodiment, the first set of prediction policies includes a plurality of vehicle maneuvers.

In one embodiment, the difference between the predicted path and the actual path is a sum-of-squares difference.

### DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a traffic pattern prediction system, in accordance with various embodiments;

FIG. 2 is a functional block diagram illustrating a transportation system having one or more autonomous vehicles as shown in FIG. 1, in accordance with various embodiments;

FIG. 3 is functional block diagram illustrating an autonomous driving system (ADS) associated with an autonomous vehicle, in accordance with various embodiments;

FIG. 4 is a top-down, conceptual view of an example roadway and vehicles helpful in describing various embodiments;

FIG. 5 is a dataflow diagram illustrating a path prediction module in accordance with various embodiments;

FIG. 6 is a dataflow diagram illustrating a policy learning module in accordance with various embodiments;

FIG. 7 is a flowchart illustrating a control method for controlling the autonomous vehicle in accordance with various embodiments; and

FIG. 8 illustrates the clustering of ill-described objects to determine object classes.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning, image analysis, neural networks, vehicle kinematics, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

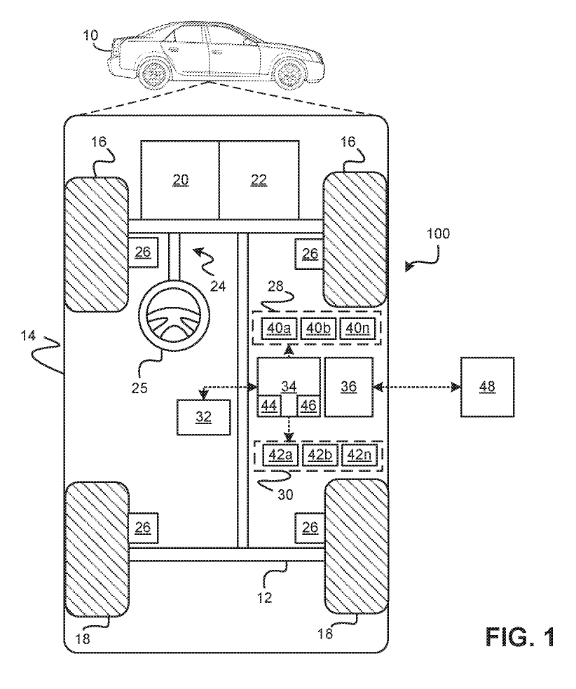

With reference to FIG. 1, a traffic pattern prediction system shown generally as 100 is associated with a vehicle 10 in accordance with various embodiments. In general, traffic pattern prediction system (or simply “system”) 100 is configured to predict the future path (or “trajectory”) of objects based on observations related to those objects (e.g., object positions, classification, and kinematics) as well as information regarding the nature of the nearby roadway (i.e., “road semantics”).

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the traffic pattern prediction system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

In an exemplary embodiment, the autonomous vehicle 10 corresponds to a level four or level five automation system under the Society of Automotive Engineers (SAE) “J3016” standard taxonomy of automated driving levels. Using this terminology, a level four system indicates “high automation,” referring to a driving mode in which the automated driving system performs all aspects of the dynamic driving task, even if a human driver does not respond appropriately to a request to intervene. A level five system, on the other hand, indicates “full automation,” referring to a driving mode in which the automated driving system performs all aspects of the dynamic driving task under all roadway and environmental conditions that can be managed by a human driver. It will be appreciated, however, the embodiments in accordance with the present subject matter are not limited to any particular taxonomy or rubric of automation categories.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n might include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, autonomous vehicle 10 may also include interior and/or exterior vehicle features not illustrated in FIG. 1, such as various doors, a trunk, and cabin features such as air, music, lighting, touch-screen display components (such as those used in connection with navigation systems), and the like.

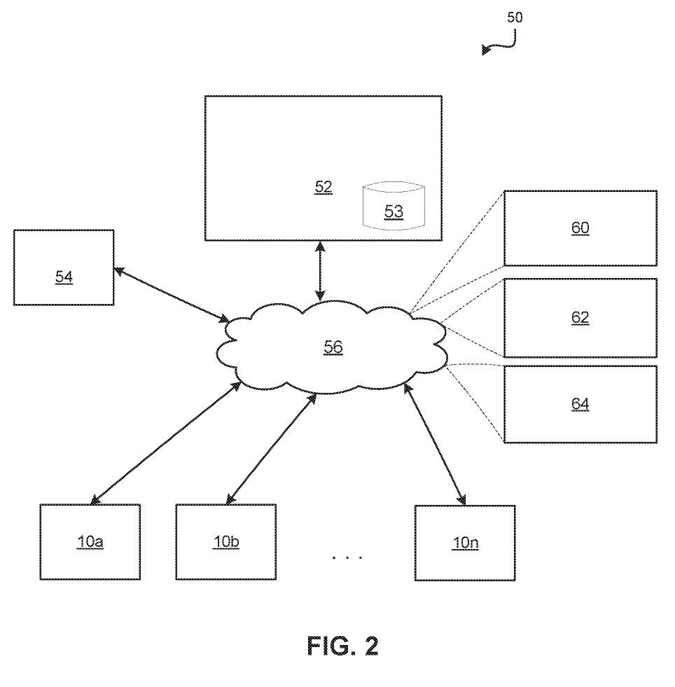

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. Route information may also be stored within data device 32—i.e., a set of road segments (associated geographically with one or more of the defined maps) that together define a route that the user may take to travel from a start location (e.g., the user's current location) to a target location. As will be appreciated, the data storage device 32 may be part of the controller 34, separate from the controller 34, or part of the controller 34 and part of a separate system.

The controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals that are transmitted to the actuator system 30 to automatically control the components of the autonomous vehicle 10 based on the logic, calculations, methods, and/or algorithms. Although only one controller 34 is shown in FIG. 1, embodiments of the autonomous vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10. In one embodiment, as discussed in detail below, controller 34 is configured to predict the trajectory of objects in the vicinity of AV 10.

The communication system 36 is configured to wirelessly communicate information to and from other entities 48, such as but not limited to, other vehicles (“V2V” communication), infrastructure (“V2I” communication), remote transportation systems, and/or user devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system (or simply “remote transportation system”) 52 that is associated with one or more autonomous vehicles 10a-10n as described with regard to FIG. 1. In various embodiments, the operating environment 50 (all or a part of which may correspond to entities 48 shown in FIG. 1) further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 may include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a component of a home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, not shown), which may be cloud-based, network-based, or resident at the particular campus or geographical location serviced by the remote transportation system 52. The remote transportation system 52 can be manned by a live advisor, an automated advisor, an artificial intelligence system, or a combination thereof. The remote transportation system 52 can communicate with the user devices 54 and the autonomous vehicles 10a-10n to schedule rides, dispatch autonomous vehicles 10a-10n, and the like. In various embodiments, the remote transportation system 52 stores store account information such as subscriber authentication information, vehicle identifiers, profile records, biometric data, behavioral patterns, and other pertinent subscriber information. In one embodiment, as described in further detail below, remote transportation system 52 includes a route database 53 that stores information relating to navigational system routes and also may be used to perform traffic pattern prediction.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

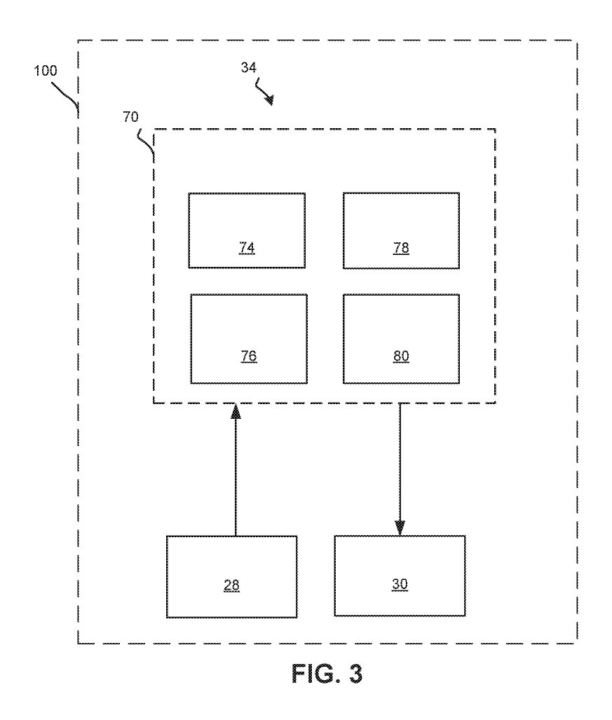

In accordance with various embodiments, controller 34 implements an autonomous driving system (ADS) 70 as shown in FIG. 3. That is, suitable software and/or hardware components of controller 34 (e.g., processor 44 and computer-readable storage device 46) are utilized to provide an autonomous driving system 70 that is used in conjunction with vehicle 10.

In various embodiments, the instructions of the autonomous driving system 70 may be organized by function or system. For example, as shown in FIG. 3, the autonomous driving system 70 can include a sensor fusion system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the sensor fusion system 74 synthesizes and processes sensor data and predicts the presence, location, classification, and/or path of objects and features of the environment of the vehicle 10. In various embodiments, the sensor fusion system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the traffic pattern prediction system 100 is configured to predict the trajectory of vehicles and other objects in the vicinity of AV 10 and iteratively improve those predictions over time based on its observations of those objects. In some embodiments, this functionality is incorporated into sensor fusion system 74 of FIG. 2.

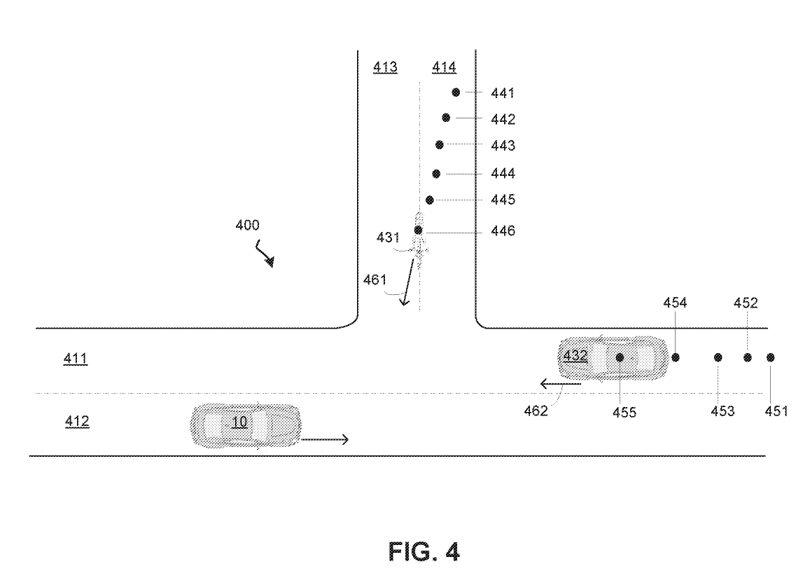

In that regard, FIG. 4 is a top-down, conceptual view of a roadway useful in describing various embodiments that might be employed in conjunction with the ADS 70 of FIG. 3. More particularly, FIG. 4 illustrates an AV 10 traveling (to the right in the figure) along a lane 412 of roadway 400. Also illustrated in FIG. 4 are two moving objects: object 431 (illustrated as a motorcycle), and object 432 (illustrated as a vehicle similar to AV 10). As mentioned above, the present subject matter is focused on traffic pattern prediction—i.e., how AV 10 can more accurately predict the future paths and kinematics (also referred to herein as “trajectories”) of objects 431 and 432 given the information available to AV 10.

In general, AV 10 is configured to utilize sensor data (e.g., from sensor system 28 of FIG. 1) as well as other data available to system 100 to observe the behavior and nature of objects 431 and 432 over time. In one embodiment, for example, a sequence of locations can be determined for both objects 431 and 432. Thus, as shown AV 10 is adapted to observe that object 431 has traveled along a path that can be substantially characterized by a series of points or positions 441-446, with position 446 being the last or “current” position (assuming FIG. 4 illustrates a snapshot at a particular time). Similarly, object 432 has progressed along a path characterized by positions 451-455.

AV 10 may estimate the spatial orientations 461 and 462 of objects 431 and 432 based on their respective paths and other available sensor data. For example, as shown in FIG. 4, object 431 appears to be oriented toward the lower left (as viewed from the top) consistent with an attempt to change from lane 414 to lane 413. Conversely, object 432 appears to have an orientation consistent with traveling straight within lane 411 toward AV 10.

The sequence of object positions (e.g., 441-446 and 451-455) may be represented and stored using any convenient data structure and metric known in the art. Furthermore, it will be appreciated that the distribution and number of positions used by the system is not limited by this example. Any number of such positions may be determined for objects 431 and 432, and the rate at which such positions are acquired may also vary depending upon design considerations.

In accordance with various embodiments, the size, geometry, dimensions, and other such aspects of objects 431 and 432 are estimated. In accordance with other embodiments, AV 10 is further configured to estimate the kinematic behavior of objects 431 and 432. As used herein, the terms “kinematic behavior” and “kinematic estimate” as applied to an object refers to a collection of parameters and values that may be used to characterize the motion of these objects, generally without reference to the forces that gave rise to such motion. Kinematic parameters might include, for example, the respective velocities of objects 431, 432 (i.e., their speeds and directions) and the instantaneous acceleration of objects 431, 432. Kinematic parameters may also include turn rates for objects 431, 432. These kinematic parameters may be determined in a variety of ways, as is known in the art.

In accordance with various embodiments, AV 10 has, generally speaking, a semantic understanding of roadway 400 (i.e., “road semantics”). Such road semantics might include, for example, road labels (e.g., for the lanes 411-414), lane boundaries, lane connectivity, drivable areas of the roadway 400, etc. Such information may be derived, for example, from map data of the type that would typically be available to AV 10 and described above in connection with FIG. 3.

In various embodiments, AV 10 is configured to observe, detect, and classify objects 431 and 432 utilizing, for example, machine learning techniques applied to lidar, radar, and image data acquired via sensor system 28. That is, given the example shown in FIG. 4, AV 10 and its various subsystems are configured to classify objects 431 and 432 as a standard motorcycle and a standard sedan, respectively. Such classifications may be subsequently used (e.g., by a trained machine model) to aid in the prediction of the trajectories of those objects.

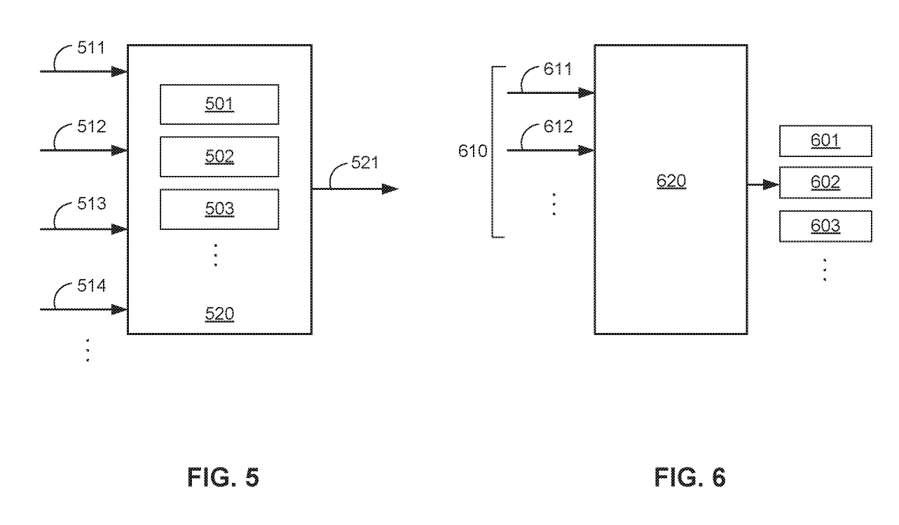

Referring now to FIGS. 5 and 6. Systems in accordance with various embodiments include two modules: a path prediction module 520 implemented within AV 10 (e.g., within ADS 70 of FIG. 3), and a policy learning module 620 implemented, for example, within an offline system such as system 52 of FIG. 2.

Referring first to FIG. 5, path prediction module 520 is configured to receive a sequence of object positions 511 (e.g., positions 441-446), a kinematic estimate 512 of each object (e.g., the velocity and acceleration of object 431), road semantics 513 (as described above), and a classification of each object (e.g., the classification of object 431 as a “motorcycle”). Together, inputs 511-514 may be referred to herein as “traffic pattern data.” Path prediction module 520 may also incorporate into the traffic pattern data any other available information that might be relevant to traffic pattern prediction. Such information might include, for example, traffic light states, background audio indicating a siren or a train horn, flashing police lights, turn signals and/or hazard lights observed on nearby vehicles, or the like.

Path prediction module 520 stores or otherwise has access to a set of policies 501-503 that, as described in further detail below, allow module 520 to produce an output 521 corresponding to a prediction of the future path(s) of the observed object or objects. In various embodiments, the accuracy of module 520 is continually improved by iteratively adapting policies 501-503 to accommodate “ill-described” classes of objects (via policy learning module 620, as described in further detail below).

The term “policy” or “prediction policy” as used herein refers to a procedure, model, set of criteria, or the like that takes as its input the characteristics of an object and its environment (e.g., the sum total of inputs 511-514) and produces a predicted path for that object. Thus, policies 501-503 are “prediction policies” in the sense that they are guidelines, rules, etc. for predicting the behavior of an object based on past knowledge regarding that type of object in similar circumstances and similar road semantics. Thus, policies 501-503 will generally correspond to different classes of objects and maneuvers, and module 520 will attempt to select which policy 501-503 best fits an object and/or maneuver, based on inputs 511-514 and past experience (e.g., via supervised, unsupervised, and/or reinforcement learning). In some embodiments, vehicles may interact with each other in such a way that the behavior and/or policies of one vehicle may be used to influence the policies of another vehicle. That is, policies 501-503 of AV 10 may be interactively modified based on the policies and behavior of other autonomous or non-autonomous vehicles in the vicinity.

For example, path prediction module 520, receiving inputs 511-514 corresponding to object 431 (i.e., the motorcycle) of FIG. 4, might determine that object 431 best fits policy 501, corresponding to the case where an object is moving at constant speed and performing a lane change. In such a case, module 521 might then produce an output (consistent with policy 501) predicting that object 431 will continue to move in a straight line to change lanes and thereafter adjust its orientation to resume within the new lane 413 at a constant speed. Similarly, module 520 might determine that object 432 best fits policy 502, corresponding to the case of a vehicle accelerating but staying within a lane in oncoming traffic. Module 520 can then easily predict the likely position and kinematics of object 432 in the near term. It will be appreciated that module 520 may implement any number of policies.

Path prediction module 520 (as well as policy learning module 620) may be implemented using any desired combination of hardware and software. In some embodiments, one or more of modules 520, 620 implement a machine learning (ML) model. A variety of ML techniques may be employed, including, for example, multivariate regression, artificial neural networks (ANNs), random forest classifiers, Bayes classifiers (e.g., naive Bayes), principal component analysis (PCA), support vector machines, linear discriminant analysis, clustering algorithms (e.g., KNN, K-means), and/or the like. In some embodiments, multiple ML models are used (e.g., via ensemble learning techniques).

It will be understood that the sub-modules shown in FIGS. 5 and 6 can be combined and/or further partitioned to similarly perform the functions described herein. Inputs to modules 520, 620 may be received from the sensor system 28, received from other control modules (not shown) associated with the autonomous vehicle 10, received from the communication system 36, and/or determined/modeled by other sub-modules (not shown) within the controller 34 of FIG. 1.

Referring now to FIG. 6 in conjunction with FIG. 5, a policy learning module 620 may be used to iteratively improve and/or supplement policies 501-503 based on past attempts to predict object trajectories. In general, policy learning module 620 is configured to receive data 610 (e.g., data 611, 612, etc.) associated with ill-described objects—that is, data associated with outputs 521 of path prediction module 520 that were unsuccessful at predicting the path/kinematics of observed objects—and produce a set of new policies 601 that may be used to supplement and/or replace policies 501-503 of path prediction module 520. Inputs 610 may correspond, for example, to the inputs 511-514 that were previously used by path prediction module 520 to predict the paths of the ill-described objects.

In some embodiments, path prediction module 520 determines (periodically or in real-time) which outputs 521 should be considered “ill-described,” and that data is subsequently uploaded to an off-line system, such as system 52 of FIG. 2, which implements policy learning module 620. In this way, the new/improved policies 601 can be provided (e.g., downloaded via system 52) to other autonomous vehicles (e.g., within a fleet of such vehicles). In addition, similar ill-described objects may be “clustered” or otherwise categorized based on certain similarities (e.g., kinematics, road semantics, object class, etc.).

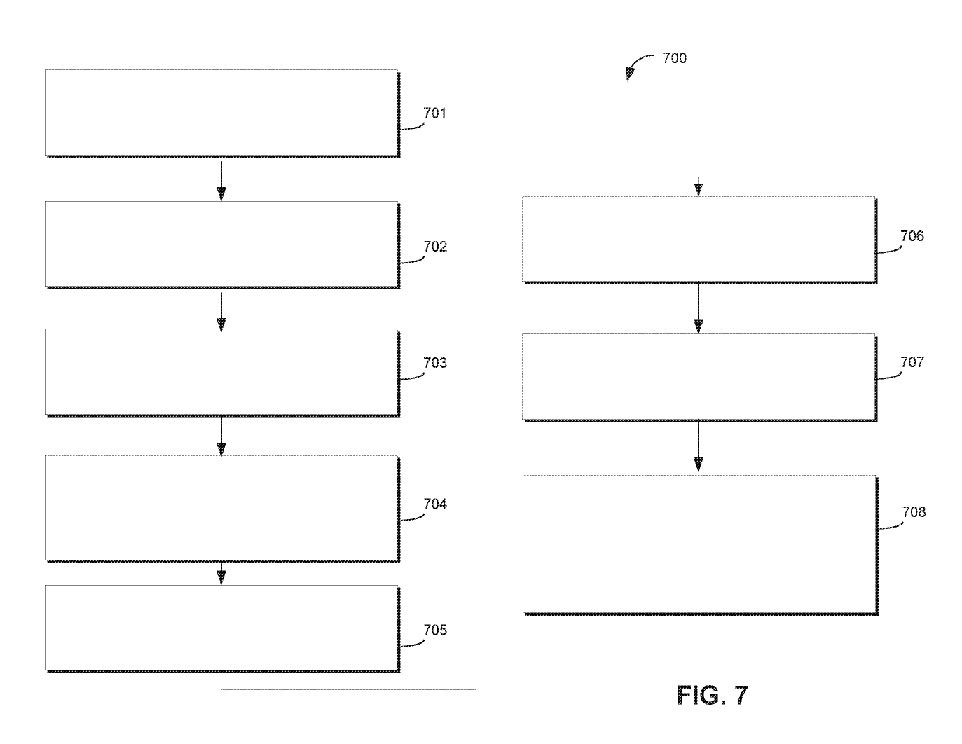

Referring now to FIG. 7, and with continued reference to FIGS. 1-6, a flowchart illustrates a control method 700 that can be performed by the system 100 in accordance with the present disclosure. As can be appreciated in light of the disclosure, the order of operation within the method is not limited to the sequential execution as illustrated in FIG. 7, but may be performed in one or more varying orders as applicable and in accordance with the present disclosure. In various embodiments, the method 700 can be scheduled to run based on one or more predetermined events, and/or can run continuously during operation of the autonomous vehicle 10.

First, at 701, a set (e.g., a “first set”) of policies (e.g., 501-503) are provided. The nature of policies 501-503 are described above, but in general correspond to expected behaviors for different position sequences, kinematics, and classes of those objects, as well as the applicable road semantics (e.g., inputs 511-514 to module 520). In some embodiments, a large number of policies are provided; in others, a minimal number of policies are used initially, assuming that subsequent learning (by module 620) based on experience will further populate and refine those policies.

Next, at 702, AV 10 collects traffic pattern data associated with objects observed in its vicinity. As described above, such traffic pattern data might include, for each detected object, a sequence of positions 511, a kinematic estimate 512, and a classification 514. Subsequently, or at the same time, the system determines (e.g., recalls, downloads, etc.) road semantics 513 applicable to the region in which AV 10 is operating (e.g., the expected layout of lanes 411-414 in roadway 400).

At 704, path prediction module 520 attempts to select a “best fit” policy (e.g., 501, 502, or 503) for each of the observed objects (e.g., 431 and 432) based on inputs 511-514. This may be accomplished using, for example, an artificial neural network (ANN) model or other such machine learning model typically used to solve classification problems, as described above.

Next, at 704, the module 520 tracks and determines the future of behavior of the observed objects (e.g., 431 and 432), and determines whether any of those objects are “ill-described” classes of objects. As used herein, the term “ill-described” refers to an object or class of objects in which the predicted behavior (as determined via policies 501-503) diverges from the actual (future) behavior by some predetermined “distance” or amount. The metric used for determining “ill-described” classes may vary. For example, this metric may be based on a difference (e.g., sum-of-squares difference) between the actual and predicted paths and/or kinematic values of an object. If the calculated difference is above some predetermined threshold, then that object is categorized as “ill-described.”

Given the set of “ill-described” objects and data relating thereto (610), policy learning module 620 then groups or clusters those objects into object classes. That is, module 620 examines the ill-described object data 610 and attempts to determine whether certain objects have some features in common. Consider, for example, object 431 in FIG. 4, and consider the case in which path prediction module 520 has not yet learned to recognize that such objects are likely to be changing lanes at a constant velocity. That is, module 520 might have previously predicted that object 431 was likely to remain in the same lane 414 and then subsequently observed that it did not (such that it diverged from the predicted trajectory by more than a predetermined amount). In such cases, module 620 might group this occurrence along with other ill-described objects relating to the inability to predict lane changes by similar objects having similar kinematics (512) in the context of similar road semantics (513).

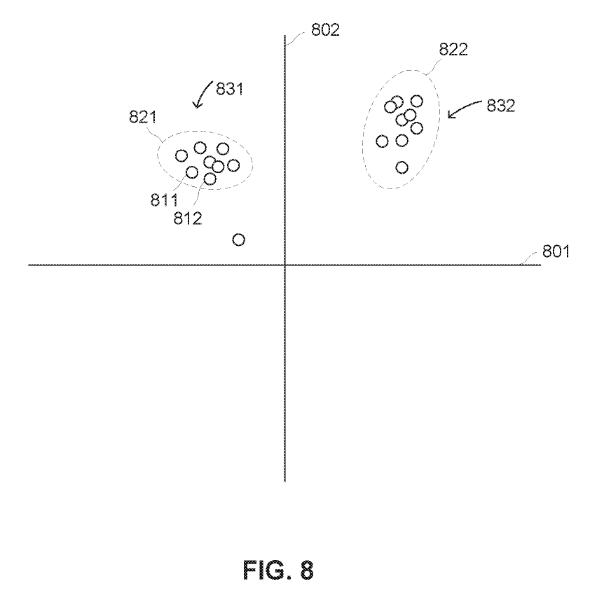

One way to determine such object classes for ill-described objects is illustrated in FIG. 8. In general, this figure illustrates a number of objects (811, 812, etc.) distributed in two-dimensional space based on two parameters 801 and 802 (which may correspond, for example, to object type, velocity, lane shape, or any other feature of inputs 511-514). It will be appreciated that, in most applications, this parameter space might include two, three, or more dimensions, as is known in the art. Nevertheless, in FIG. 8 it can be seen that some objects (as described by their corresponding data) are sufficiently close to each other that they form a cluster 821, while others form a cluster 822. Module 620 may then conclude that the objects in cluster 821 belong in a class 831, while objects in cluster 822 belong in another class 832. A variety of conventional clustering techniques (such as K-nearest-neighbor, K-means, or the like) may be used to accomplish this grouping.

Next, at 707, module 620 determines a new set of policies for the classes determined for the ill-described objects in step 706. This may be accomplished, for example, by supervised training of module 520 using the previous determined inputs 511-514 and the actual behavior observed in those objects. Subsequently, at 708, a new set of policies are provided to module 520 based on the new set of policies and the previous, “first” set of policies provided at 701. Steps 701-708 may then be continually performed during operation of AV 10. In this way, the set of policies will tend to improve and be refined over time, allowing module 520 to iteratively learn to recognize and predict the behavior of a wide range of object classes.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of predicting traffic patterns comprising:
providing, within an autonomous vehicle, a first set of prediction policies;
receiving traffic pattern data associated with an object observed by the autonomous vehicle, the traffic pattern data including a kinematic estimate for the object, a position sequence for the object, and road semantics associated with a region near the object;
determining a predicted path for the object based on the first set of prediction policies and the traffic pattern data;
determining an actual path for the object;
determining a new prediction policy for the object if the difference between the predicted path and the actual path is above a predetermined threshold; and
providing, within the autonomous vehicle, a second set of prediction policies based on the first set of prediction policies and the new policy.

2. The method of claim 1, wherein the kinematic estimate includes at least one of a velocity, an acceleration, and a turn rate of the observed object.

3. The method of claim 1, wherein the traffic pattern data further includes an estimate of the physical dimensions of the object.

4. The method of claim 1, wherein determining the new prediction policy is performed by a server remote from the autonomous vehicle.

5. The method of claim 1, wherein the first set of prediction policies includes a plurality of vehicle maneuvers.

6. The method of claim 1, wherein the difference between the predicted path and the actual path is a sum-of-squares difference.

7. The method of claim 1, wherein the road semantics include at least one of road labels, lane boundaries, lane connectivity, and drivable areas of the roadway.

8. A system for controlling a vehicle, comprising:
a sensor system configured to observe an object in an environment associated with the vehicle;
a policy learning module, communicatively coupled to the sensor system, including a first set of prediction policies, the policy learning module configured to:
receive traffic pattern data associated with an object observed by the autonomous vehicle, the traffic pattern data including a kinematic estimate for the object, a position sequence for the object, and road semantics associated with a region near the object;
determine a predicted path for the object based on the first set of prediction policies and the traffic pattern data;
determine an actual path for the object;
determine a new prediction policy for the object if the difference between the predicted path and the actual path is above a predetermined threshold; and
modify the first set of prediction policies based on the new policy.

9. The system of claim 8, wherein the kinematic estimate includes at least one of a velocity, an acceleration, and a turn rate of the observed object.

10. The system of claim 8, wherein the traffic pattern data further includes an estimate of the physical dimensions of the object.

11. The system of claim 8, wherein the new prediction policy is based on a second policy associated with a second vehicle.

12. The system of claim 8, wherein the first set of prediction policies includes a plurality of vehicle maneuvers.

13. The system of claim 8, wherein the difference between the predicted path and the actual path is a sum-of-squares difference.

14. The system of claim 8, wherein the road semantics include at least one of road labels, lane boundaries, lane connectivity, and drivable areas of the roadway.

15. An autonomous vehicle comprising:
a sensor system configured to observe an object in an environment associated with the vehicle;
a policy learning module, communicatively coupled to the sensor system, including a first set of prediction policies, the policy learning module configured to:
receive traffic pattern data associated with an object observed by the autonomous vehicle, the traffic pattern data including a kinematic estimate for the object, a position sequence for the object, and road semantics associated with a region near the object;
determine a predicted path for the object based on the first set of prediction policies and the traffic pattern data;
determine an actual path for the object;
determine a new prediction policy for the object if the difference between the predicted path and the actual path is above a predetermined threshold; and
modify the first set of prediction policies based on the new policy.

16. The autonomous vehicle of claim 15, wherein the kinematic estimate includes at least one of a velocity, an acceleration, and a turn rate of the observed object.

17. The autonomous vehicle of claim 15, wherein the traffic pattern data further includes an estimate of the physical dimensions of the object.

18. The autonomous vehicle of claim 15, wherein the new prediction policy is determined by a server remote from the autonomous vehicle.

19. The autonomous vehicle of claim 15, wherein the first set of prediction policies includes a plurality of vehicle maneuvers.

20. The autonomous vehicle of claim 15, wherein the difference between the predicted path and the actual path is a sum-of-squares difference.
